(19) United States
(12) Patent Application Publication
(10) Pub. No.: US 2020/0011472 A1
(43) Pub. Date: Jan. 9, 2020

(54) OILFIELD TUBING AND METHODS FOR MAKING OILFIELD TUBING

(71) Applicant: Wei XIE, Surrey (CA)

(72) Inventor: Wei XIE, Surrey (CA)

(21) Appl. No.: 16/026,066

(22) Filed: Jul. 3, 2018

(51) Int. Cl. F16L 58/18; F16L 58/08

(52) U.S. Cl. CPC F16L 58/182; E21B 17/1007; F16L 58/08

(57) ABSTRACT

A corrosion resistant tube and a corrosion resistant tubing connector and methods for making them are disclosed. The tube comprises a tube section main body which is hollow and cylindrical in shape and having two end portions, each end portion having threads, an internal anti-corrosion coating layer on the inner surface of the tube section, an external anti-corrosion coating layer at each of the end portions, and an end anti-corrosion coating layer at each of the end portions. The internal anti-corrosion coating layer, the external anti-corrosion coating layer, and the end anti-corrosion coating layer are resistant to corrosive elements present in crude oil or natural gas.

### TECHNICAL FIELD

The present invention relates in general to tubes and pipes, especially tubing for use in oil wells and other wells, and to methods for making these tubes and pipes.

### BACKGROUND

Tubes and pipes are used to transport oil or natural gas from the hydrocarbon reservoir to the earth surface. Tubes and pipes are usually hollow and cylindrical in shape. Oil is generally removed from the ground using a pump-jack. This equipment is mounted on the surface of the earth above an oil reservoir. The pump-jack is connected to a down-hole pump located at the bottom of an oil well by a string of interconnected sucker rods, which extends inside a string of tubes. In some technical literature, this string of tubes is referred to as production tubing. Through the action of the pump-jack, oil is pumped from the reservoir to the surface for collection.

Corrosion in the oilfield can be caused by many sources: hydrogen sulfide (H₂S), carbon dioxide (CO₂), dissolved oxygen, brinish disposal water, highly acidic soil conditions and many others. Crude oil and natural gas can carry various high-impurity products which are inherently corrosive. Continual extraction of CO₂, H₂S, and water through oil and gas components can over time make the internal surfaces of these components to suffer from corrosion effects. Corrosion reduces productivity, and causes downtime for maintenance, or worse, replacement. Each year, corrosion costs oil and gas operating companies billions of dollars in lost revenue and reduced operating profit.

Several conventional methods are currently available for reducing corrosion of the internal surfaces of tubes and pipes used in the oil and natural gas industry.

One method is to provide a lining to the internal core of the tubes and pipes. In some instances, the lining for these tubes and pipes is made of a non-metal material such as polythene (PE) or high density polyethylene (HDPE). A disadvantage with this type of lining is the lining's poor temperature resistance. The maximum temperature cannot exceed 80° C. This type of lining is not suitable for deep thermal recovery wells. Also, this type of lining is not suitable for heavy oil or bitumen recovery, because heavy oil or bitumen is very dense and requires steam (sometimes having a temperature of up to 300° C.) to get the bitumen up from underground. Additionally, the temperature for washing this type of lining cannot be very high either. Therefore, the application of this type of lining is rather limited. In some instances, the internal lining consists of stainless steel or ceramic materials. Because the lining material and the base material of the oilfield tubing may have different thermal elongation rates, this also causes a problem in its use. Additionally, this type of lining has an inner lining thickness of 3 mm-5 mm, so that the inner diameter of the oilfield production tubing becomes smaller by 6mm-10mm, thereby affecting the performance of the oilfield production tubing.

Another method is to coat the internal surfaces of the tubes and pipes with epoxy powder coating to achieve some level of anti-corrosion effect. Since the bonding between the epoxy coating material and the substrate of the tubes and pipes is a mechanical bonding, the bonding strength is only in the range of 20 MPa to 70 MPa. This type of epoxy coating has poor resistance to abrasion and high temperature.

Another method is plating, for example, electroplating. Although plating may provide good temperature resistance, the layer created by plating could easily peel off in some complex oil well conditions. Additionally, the plating process can cause serious environmental problems. The plating process is not environmentally friendly.

Therefore, it is desirable to provide methods for making tubes and pipes which are resistant to corrosion in environments like those found in oil wells. It is also desirable to provide tubes and pipes which are resistant to corrosion for use in the oil and natural gas industry.

### BRIEF DESCRIPTION OF DRAWINGS

In drawings which show non-limiting embodiments of the invention:

FIG. 1 shows a tube section attached to a tubing connector according to an example embodiment of the invention.

FIG. 2 shows the tube section of FIG. 1.

FIG. 3 illustrates a method of making the tube section of FIG. 1 according to an example embodiment of the invention.

FIG. 4 shows the tubing connector of FIG. 1

FIG. 5 illustrates a method of making the tubing connector of FIG. 1 according to an example embodiment of the invention.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

One aspect of the invention relates to tubes and pipes which are resistant to corrosion and methods of making these tubes and pipes. This aspect of the invention is applicable to oilfield tubing, casing, and oil pump barrels. This aspect of the invention is also applicable to oil and natural gas transport pipes.

One aspect of the invention relates to methods of coating the internal surfaces of tubes and pipes. The oilfield tubes are usually hollow and cylindrical in shape. Each tube has a longitudinal axis, an inner wall with an annular surface, and a predetermined inner diameter. The dimensions of oilfield tubes are usually regulated by API (American Petroleum Institute) standards. The length of such oilfield tubes can be 9 meters (9000 mm) or more, whereas the internal diameter (ID) is in the range of 40-90 mm. Therefore, the length/ID ratio of these oilfield tubes is 100:1 or more. In some embodiments, the oilfield tube is formed of low carbon alloy steel materials.

One aspect of the invention relates to methods of forming an anti-corrosion layer on an inner or outer surface of a tube. An example method comprises preheating metal or alloy powder at a first temperature range (e.g., 200° C.-450° C.) and depositing the preheated metal or alloy powder on a surface of the oilfield tube to form a coating layer. The method also comprises heating the deposited metal or alloy powder coating layer on the surface of the oilfield tube to a second temperature range (e.g., 760° C.-1300° C.) which is higher than the first temperature range to melt the powder, such that slag float to the top of the coating layer and the resulting silicides and borides are dispersed in the coating layer. The particles of the metal or alloy powder and the substrate (i.e., the oilfield tube) are bonded. The final coating layer is a dense crystalline structure comprising a metallurgical bonding layer bonded with the tube substrate. The bonding strength of the coating layer is about 200 MPa or higher. The coating layer formed using this method has resistance to impact, resistance to wear, resistance to corrosion, and has a mirror-like appearance. When used in the oilfield, the coating layer protects the underlying tube substrate from corrosion, and unlike epoxy coating, the metal or alloy coating layer generated this way does not peel off easily.

Another example method of forming an anti-corrosion layer on an inner surface of a tube involves centrifugal welding (also known as centrifugal casting). The method comprises preheating the tube to be coated to a temperature range which is high enough to melt the metal or alloy powder for coating the tube (for example a temperature range of 900° C.-1300° C.), and while rotating the tube, pouring the molten metal or alloy powder into the tube such that the molten metal or alloy powder is spun by a centrifugal force and deposited evenly on the internal surface of the tube, and then forming a coating layer by cooling down the tube. The bonding strength of the coating layer formed using this centrifugal welding method is also about 200 MPa or higher.

The alloy coating may comprise a superalloy material characterized by high resistance to wear and corrosion. Superalloy is an alloy that usually comprises one or more of Fe, Ni, Co, and Cr. In some embodiments, the alloy coating comprises a Ni-based alloy. In some embodiments, the alloy coating comprises a Co-based alloy. In some embodiments, the alloy coating comprises a Fe-based alloy. In some example embodiments, the percentage of Ni by weight in the Ni-based alloy may be more than 50%, or more than 60%, or more than 70%. In some example embodiments, the percentage of Cr by weight in the Ni-based alloy may be in the range of 5% to 20%, or 10% to 15%. In some example embodiments, the Ni-based alloy for alloy coating may comprise in percentage by weight 70-80% Ni, 10-15% Cr, 0-8% Fe, 0.2-0.4% C, 3.0-4.5% B, 0-0.02% P, 0-0.02% S.

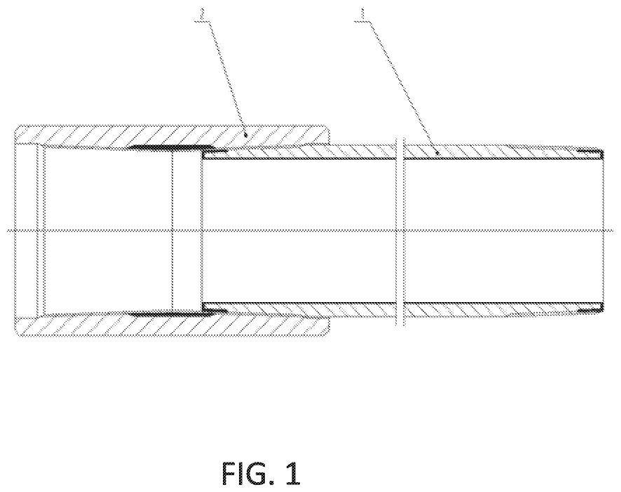

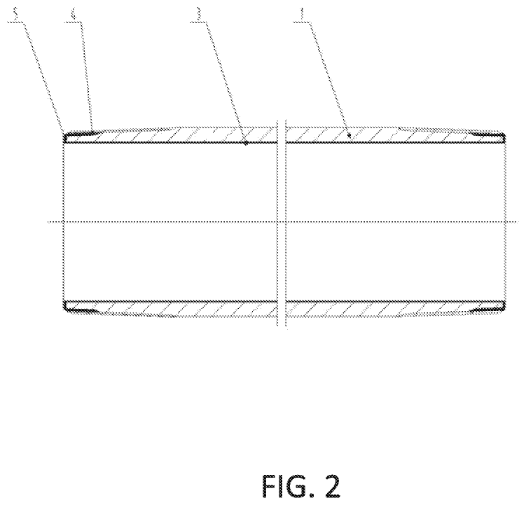

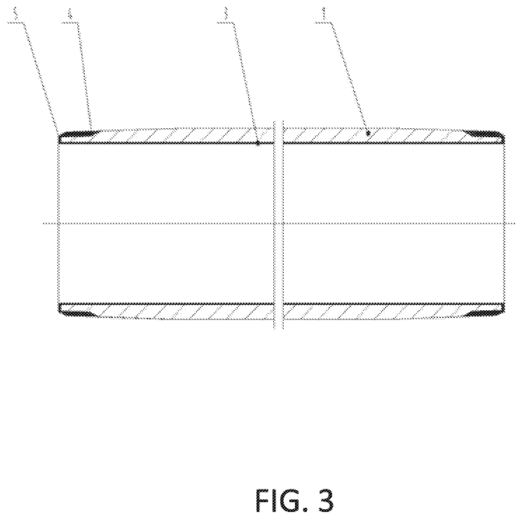

FIG. 1 shows a tube section 1 threadedly attached to a tubing connector 2 according to an example embodiment of the invention. A longitudinal axis of the tube and the tubing connector is also illustrated for reference in FIG. 1. The break lines in FIG. 1 (and also FIGS. 2 and 3) indicate that the tube section may comprise a portion between the break lines which is not shown in order to shorten the view. In accordance with API (American Petroleum Institute) standards, the tube section can be as long as 10 meters, while the outside diameter (OD) of the tube may be only 5 to 15 cm. To better show the anti-corrosion layer, the tube section and the tubing connector are shown in a sectional view. Both the tube section and the tubing connector are hollow and cylindrical in shape.

FIG. 2 shows the tube section 1 of FIG. 1. The tube section 1 comprises an internal anti-corrosion alloy layer 3, an external anti-corrosion alloy layer 4, and an end anti-corrosion alloy layer 5. Internal anti-corrosion alloy layer 3 is annular and may extend along the entire longitudinal length of the internal wall of the tube section. Internal anti-corrosion alloy layer 3 may comprise an alloy material which is resistant to corrosion. For example, internal anti-corrosion alloy layer 3 may comprise a superalloy which comprises one or more of Fe, Ni, Co, and Cr. In some embodiments, internal anti-corrosion alloy layer 3 may have a thickness of about 0.05-0.5 mm. The thinness of internal anti-corrosion alloy layer is advantageous in that it does not significantly reduce the internal diameter of the tube section. The bonding strength of layer 3 to the substrate of the tube section may be about 200 MPa or higher. Layer 3 may be generated using a suitable method, such as one of the methods disclosed in this specification. Internal anti-corrosion alloy layer 3 protects the internal wall of tube section 1 from corrosion by corrosive elements in oil or natural gas. In some embodiments, external anti-corrosion alloy layer 4 and an end anti-corrosion alloy layer 5 may have a thickness of about 0.5-3 mm.

The tube section 1 is characterized by comprising internal anti-corrosion alloy layer 3, external anti-corrosion alloy layer 4, and end anti-corrosion alloy layer 5. The tube section 1 has two end portions and each end portion comprises threads. The threads allow tube section 1 to be threaded connected to tubing connector, as is shown in FIG. 1. External anti-corrosion alloy layer 4 is located on the outside of tube section 1 at a region proximal to the threads. End anti-corrosion alloy layer 5 is located on the end face of tube section 1. Layer 4 or layer 5 may comprise an alloy material which is resistant to corrosion. For example, layer 4 or layer 5 may comprise a superalloy which comprises one or more of Fe, Ni, Co, and Cr. Layer 4 or layer 5 may have a thickness of about 0.5-3 mm. Layer 4 and layer 5 protect the threads and the end face of tube section 1 from corrosion by corrosive elements in oil or natural gas. Layer 4 and layer 5 may be generated using a suitable method, such as one of the methods disclosed in this specification.

The tube section as described in this specification is advantageous because conventional tube sections do not have this combination of anti-corrosion alloy layers, especially the combination of external anti-corrosion alloy layer and end anti-corrosion alloy layer and internal anti-corrosion alloy layer which are contiguous. This solves the problem that conventional tube sections are not resistant to corrosion at their external surface (especially the threads) and at their terminal end.

In the FIG. 2 embodiment, external anti-corrosion alloy layer 4 is located at or near the end of the tubing section. The longitudinal length of external anti-corrosion alloy layer 4 may be 5-40 mm. In this way, the thread can have anti-corrosion property without affecting the tensile strength of the thread. It is also a cost-saving feature to not cover the entire external surface of the tube section, but to cover the terminal 5-40 mm regions of the tube section which are the most vulnerable.

In some embodiments, the anti-corrosion layers are metallurgically bonded to the substrate of the tube section with bonding strength of more than 200 MPa. In some embodiments, the anti-corrosion layers are heat-resistant. This is also advantageous. As mentioned earlier, bitumen recovery may require steam (sometimes at a temperature of up to 300° C.) to get the bitumen up from underground. There are two type of heat resistance: physical heat resistance and chemical heat resistance. In some embodiments the anti-corrosion layers comprise a material that exhibits both physical heat resistance and chemical heat resistance when exposed to a temperature of up to 100° C., 200° C., 300° C., or 350° C.

FIG. 1 shows an assembly of anti-corrosion tube section 1 and anti-corrosion tubing connector 2. In this assembly, tube section 1 comprises internal anti-corrosion alloy layer 3, external anti-corrosion alloy layer 4, and end anti-corrosion alloy layer 5, and tubing connector 2 in a middle portion thereof comprises an annular internal anti-corrosion alloy layer 6. The corrosion resistance of a combination of anti-corrosion layers of the assembly can overcome the insufficiency of some conventional oil pipes.

In this assembly, the anti-corrosion layers (e.g., anti-corrosion layer 4) of tube section 1 overlap with the anti-corrosion layer 6 of tubing connector 2. This overlapping arrangement creates a seal or barrier to corrosive medium and can prevent corrosive medium flowing inside the tube section from leaking or penetrating into the back of the threads of the tube section and causes corrosion to the threads.

FIG. 3 illustrates a method of making the tube section of FIG. 1 according to an example embodiment of the invention. In this example method, the substrate or the main body of the tube section is first machined at the external surface and the terminal end. Second, external anti-corrosion alloy layer 4 and end anti-corrosion alloy layer 5 are formed on the tube section using suitable methods such as surface welding or overlay welding or methods described earlier in this specification in paragraphs 18 and 19. Third, the inner hole of the tube section is cleaned. Fourth, internal anti-corrosion alloy layer 3 is formed using suitable methods such as thermal welding methods (for example, flame spray, centrifugal casting, laser cladding methods) or methods described earlier in this specification in paragraphs 18 and 19. Fifth, the tube section undergoes a heat treatment step. Sixth, the end portions of the tube section are further machined to create threads.

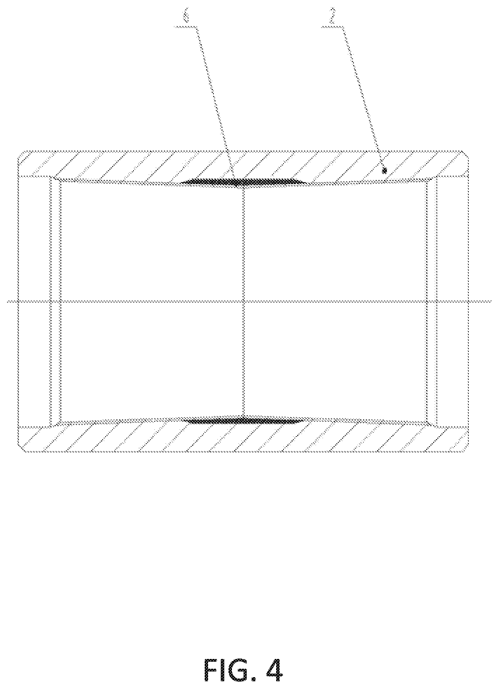

FIG. 4 shows the tubing connector of FIG. 1. The tubing connector is used to connect a series of tube sections into a string of tubes. The tubing connector 2 comprises tubing connector main body and anti-corrosion alloy layer 6. The tubing connector main body is generally made from low carbon alloy steel, whereas the alloy layer is made from a corrosion-resistant alloy. Anti-corrosion alloy layer 6 is located inside the tubing connector main body in a middle region between two threaded portions. FIG. 4 is a sectional view, but a person skilled in the art would understand that anti-corrosion alloy layer 6 can be an annular layer. As shown in FIG. 4, the tubing connector main body wall is thicker in the middle region where the anti-corrosion alloy layer 6 is located than the regions where the two threaded portions are. As can be seen in the sectional view, there is a gentle slope from the middle region to the threaded portions.

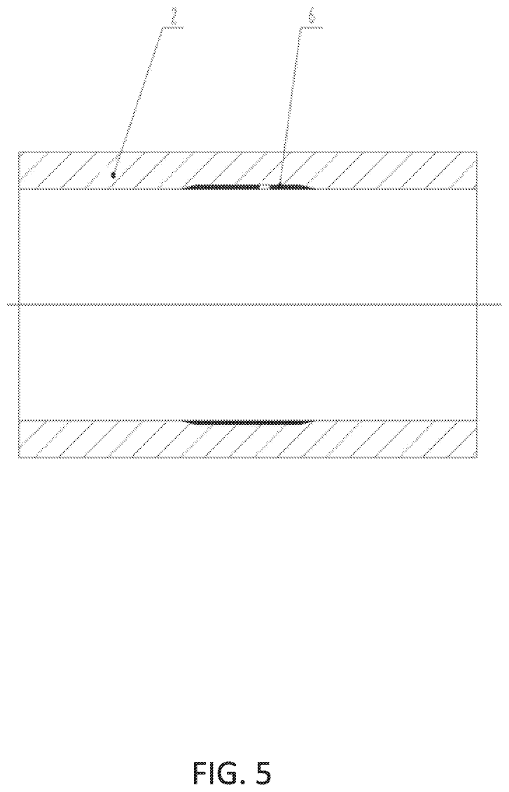

FIG. 5 illustrates a method of making the tubing connector of FIG. 1 according to an example embodiment of the invention. First, an annular groove is made on the inside of the middle region of the tubing connector main body. For example, the longitudinal length of the annular groove may be 20-60 mm and the depth of the annular groove may be 2-8 mm. Other dimensions may also be used depending on the size of the tubing connector main body and the size of the tube which the tubing connector is to be used with. Second, the anti-corrosion alloy layer is formed on the annular groove using suitable methods such as welding or methods described earlier in this specification in paragraphs 18 and 19. Third, the tubing connector undergoes a heat treatment. Fourth, the tubing connector is further processed to form the internal threads on the two regions adjacent to the middle region, such that the tubing connector can be used to threadedly connect to a tube having corresponding external threads.

As will be apparent to those skilled in the art in the light of the foregoing disclosure, many alterations and modifications are possible in the practice of this invention. The scope of the claims should not be limited by the preferred embodiments set forth in the examples, but should be given the broadest interpretation consistent with the description as a whole.

What is claimed is:

1. A tube section comprising
a tube section main body which is hollow and cylindrical in shape and having two end portions, each end portion having external threads,
an internal anti-corrosion coating layer on the inner surface of the tube section, the internal anti-corrosion coating layer extending along an entire longitudinal length of the tube section from one end portion to the other end portion,
an external anti-corrosion coating layer at each of the end portions, the external anti-corrosion coating layer covering a proximal part of the threads,
and an end anti-corrosion coating layer at each of the end portions, the end anti-corrosion coating layer covering the end face of the end portions,
wherein the internal anti-corrosion coating layer, the external anti-corrosion coating layer, and the end anti-corrosion coating layer are resistant to corrosive elements present in crude oil or natural gas.

2. The tube section according to claim 1, wherein the internal anti-corrosion coating layer, the end anti-corrosion coating layer and the external anti-corrosion coating layer are contiguous.

3. The tube section according to claim 1, wherein the external anti-corrosion coating layer extends for a longitudinal length of 5 to 40 mm, such that the external anti-corrosion coating layer does not affect the tensile strength of the threads of the tube section, and the tube section has a longitudinal length of at least 9000 mm and a length/internal diameter (ID) ratio of at least 100.

4. The tube section according to claim 1, wherein the internal anti-corrosion coating layer, the external anti-corrosion coating layer, and the end anti-corrosion coating layer are bonded to the tube section main body at a bonding strength greater than 200 MPa.

5. The tube section according to claim 1, wherein the internal anti-corrosion coating layer, the external anti-corrosion coating layer, and the end anti-corrosion coating layer can withstand an environment temperature of up to 300° C. without losing their anti-corrosion properties.

6. The tube section according to claim 1, wherein the internal anti-corrosion coating layer, the external anti-corrosion coating layer, and the end anti-corrosion coating layer are resistant to corrosion of hydrogen sulfide (H₂S), carbon dioxide (CO₂) and water present in crude oil or natural gas.

7. The tube section according to claim 1, wherein the internal anti-corrosion coating layer, the external anti-corrosion coating layer, and the end anti-corrosion coating layer are made from an alloy.

8. The tube section according to claim 7, wherein the alloy is a superalloy which comprises one or more of Fe, Ni, Co, and Cr.

9. The tube section according to claim 7, wherein the alloy is a Ni-based alloy comprising greater than 70% Ni by weight, or a Ni-based alloy comprising 5-20% Cr by weight.

10. The tube section according to claim 1, wherein the internal anti-corrosion coating layer has a thickness of 0.05-0.5 mm, and the external anti-corrosion coating layer and the end anti-corrosion coating layer have a thickness of 0.5-3 mm.

11. The tube section according to claim 1, in combination with a tubing connector, wherein the tubing connector is hollow and cylindrical in shape, and the tubing connector comprises a tubing connector main body and an annular anti-corrosion alloy layer inside the tubing connector main body in a middle portion of the tubing connector main body.

12. The tube section and the tubing connector in combination according to claim 11, wherein the tubing connector comprises two threaded internal regions which are located to either side of the annular anti-corrosion coating layer, and the threaded internal regions allow the tubing connector to be threaded connected to the tube section such that the annular anti-corrosion coating layer of the tubing connector and the external anti-corrosion coating layer of the tube section overlap to form a seal or barrier to corrosive medium and can prevent corrosive medium flowing in the tube section from leaking or penetrating into the back of the threads of the tube section.

13. The tube section and the tubing connector in combination according to claim 11, wherein the annular anti-corrosion coating layer of the tubing connector is made from an alloy.

14. The tube section and the tubing connector in combination according to claim 13, wherein the annular anti-corrosion coating layer of the tubing connector is made from a superalloy which comprises one or more of Fe, Ni, Co, and Cr.

15. A method for making the tube section as defined in claim 1, the method comprising: (1) providing a tube section to be processed, (2) machining the external surface and the end portions of the tube section to a desired shape, (3) coating the external anti-corrosion coating layer at the end portions of the tube section, (4) coating the end anti-corrosion coating layer at the end face of the tube section, (5) cleaning the internal hole of the tube section, (6) coating the internal anti-corrosion coating layer inside the tube section, and (7) machining the end portions of the tube section to create threads.

16. The method according to claim 15, wherein the internal anti-corrosion coating layer, the external anti-corrosion coating layer, and the end anti-corrosion coating layer are made using a welding process.

17. The method according to claim 15, wherein the internal anti-corrosion coating layer, the external anti-corrosion coating layer, and the end anti-corrosion coating layer are made using a thermal spraying process or a centrifugal welding process or a combination thereof.

18. A method for making the tubing connector as defined in claim 12, the method comprising: (1) providing a tubing connector to be processed, (2) generating an annular groove on the inside of the middle region of the tubing connector, (3) coating an annular anti-corrosion coating layer on the annular groove, (4) processing the tubing connector to generate threads adjacent the annular anti-corrosion coating layer such that the tubing connector can be used to threadedly connect to a tube having corresponding external threads.

19. The method according to claim 18, wherein the annular anti-corrosion coating layer is made using a welding process.

20. The method according to claim 18, wherein the annular anti-corrosion coating layer is made using a thermal spraying process or a centrifugal welding process or a combination thereof.
